(19) United States
(12) Patent Application Publication
(10) Pub. No.: US 2025/0389082 A1
(43) Pub. Date: Dec. 25, 2025

(54) IMAGE FORMING METHOD AND INK SET FOR INKJET TEXTILE PRINTING

(71) Applicant: Konica Minolta, Inc., Tokyo (JP)

(72) Inventor: Ibuki TOMIURA, Tokyo (JP)

(21) Appl. No.: 19/238,751

(22) Filed: Jun. 16, 2025

(30) Foreign Application Priority Data
Jun. 25, 2024 (JP) 2024-102198

(51) Int. Cl. D06P 5/30; C09D 11/102; C09D 11/30; C09D 11/54; D06P 1/52; D06P 5/00

(52) U.S. Cl. CPC D06P 5/30; C09D 11/102; C09D 11/30; C09D 11/54; D06P 1/5257; D06P 1/5292; D06P 5/002

(57) ABSTRACT

An image forming method includes: preparing a fabric in a dry state to which a cationic aggregating agent is attached; and applying an ink including a pigment, an anionic block copolymer, a silicone acrylic resin, and water onto the fabric by an inkjet method. The block copolymer contains a hydrophilic block A and a hydrophobic block B.

### CROSS REFERENCE TO RELATED APPLICATIONS

The entire disclosure of Japanese Patent Application No.2024-102198, filed on Jun. 25, 2024 is incorporated herein by reference in its entirety.

### BACKGROUND

### Technological Field

The present invention relates to an image forming method.

### Description of Related Art

Inkjet textile printing, in which an image is formed on a fabric by an inkjet method, has been widely performed in recent years as a fabric printing method because dyeing can be performed in a short time and production efficiency is high.

As ink used in inkjet textile printing, dye ink has been mainly used, but the use of pigment ink, which can omit post-processing such as a washing step of washing away dye that has not been dissolved or reacted, has been studied.

The pigment ink exhibits high color developability by causing the pigment particles to stay on the surface of the textile, but tends to have lower fixability of the pigment particles and poorer friction fastness than the dye ink. Therefore, studies have been conducted on enhancing the fixability of pigment particles and enhancing the friction fastness by performing a pre-treatment or a post-processing of applying an aggregating agent for aggregation of a pigment dispersion to a fabric before applying an ink.

For example, PTL 1 discloses an image forming method including the steps of: applying a pretreatment liquid containing an aggregating agent to a textile; and applying, by an inkjet method, an ink containing a pigment to the fabric to which the pretreatment liquid has been applied. In the above document, an organic acid, a cationic polymer, or the like is described as the aggregating agent contained in the pretreatment liquid.

PTL 2 discloses an image forming method including the steps of applying an ink containing a pigment to a fabric by an inkjet method, and applying a treatment liquid containing a resin emulsion onto the fabric onto which the ink has been applied. In the above-mentioned document, a cationic resin emulsion and the like are described as the resin emulsion contained in the treatment liquid.

PTL 3 discloses, as a dispersant for dispersing a pigment, a block copolymer including: an A block that includes a constituent unit derived from (meth) acrylate having an aromatic group or (meth) acrylate having a cyclic alkyl group; and a B block that includes a constituent unit derived from (meth) acrylic acid or (meth) acrylate having a carboxy group.

### CITATION LIST

### Patent Literature

### PTL 1

Japanese Unexamined Patent Publication No. 2022-180815

### PTL 2

Japanese Unexamined Patent Publication No. 2021-95497

### PTL 3

Japanese Unexamined Patent Publication No. 2021-98835

### SUMMARY OF INVENTION

### Technical Problem

Incidentally, in the image forming method as described above, it is common to perform the step of applying the treatment liquid to the fabric to attach the aggregating agent (pre-treatment step) on-line. On the other hand, for example, when a function other than aggregation is required for the treatment liquid, the pretreatment step may be performed off-line.

However, in the case where the pretreatment step is performed off-line, it tends to be difficult to obtain the friction fastness of the image-formed product as compared with the case where the pretreatment step is performed on-line. It is thought that this is because in a case where the pretreatment step is performed off-line, the ink is applied to the fabric in a dry state, and thus an interaction between the aggregating agent attached to the fabric and the pigment dispersion in the ink is less likely to occur, compared to an on-line case where the ink is applied to the fabric in a wet state.

On the other hand, according to the studies of the present inventors, it has been found that an image having high friction fastness can be formed even on a fabric in a dry state by using, as a pigment-dispersing agent, a block copolymer including two hydrophilic blocks A disposed at both ends of the molecule and a hydrophobic block B disposed therebetween. On the other hand, a new problem has been found that the use of the block copolymer tends to cause density unevenness and color unevenness in an image to be obtained.

The present invention has been made in view of the above-described problems, and it is an object of the present invention to provide an image forming method capable of forming an image having high friction fastness on a fabric while suppressing density unevenness and color unevenness even on a fabric treated off-line.

### SUMMARY

The present invention relates to the following image forming method.

[1] An image forming method comprising: preparing a fabric in a dry state to which a cationic aggregating agent is attached, and applying an ink comprising a pigment, an anionic block copolymer, a silicone acrylic resin, and an aqueous solvent onto the fabric by an inkjet method, wherein the anionic block copolymer contains a hydrophilic block A and a hydrophobic block B.

[2] The image forming method according to [1], wherein the preparing the fabric includes applying a treatment liquid including the cationic aggregating agent and the aqueous solvent to the fabric, and drying the fabric to which the treatment liquid has been applied.

[3] The image forming method according to [2], wherein in the drying, the drying is performed until a remaining amount of the aqueous solvent in the fabric becomes 20% by mass or less with respect to a total amount of the aqueous solvent applied to the fabric.

[4] The image forming method according to any one of [1] to [3], wherein the anionic block copolymer contains two hydrophilic blocks A disposed at both ends of a molecule of the anionic block copolymer and the hydrophobic block B disposed between the two hydrophilic blocks A, each of the two hydrophilic blocks A being one of a plurality of the hydrophilic blocks A.

[5] The image forming method according to any one of [1] to [4], wherein: the silicone acrylic resin includes a constituent unit X derived from a polyorganosiloxane having a radically polymerizable group, and a constituent unit Y derived from a (meth) acrylic acid ester; and a content of the constituent unit X is 80% by mass or more and 99% by mass or less with respect to a sum of an amount of the constituent unit X and an amount of the constituent unit Y.

[6] The image forming method according to any one of [1] to [5], wherein the weight average molecular weight of the silicone acrylic resin is 1,000 or more and 500,000 or less.

[7] The image forming method according to any one of [1] to [6], wherein a content of the silicone acrylic resin in the ink is 0.2% by mass or more and 10% by mass or less with respect to the ink.

[8] The image forming method according to any one of [1] to [7], wherein the ink further includes a water-dispersible resin different from the anionic block copolymer.

[9] The image forming method according to any one of [1] to [8], further including applying a second treatment liquid including a water-dispersible resin and an aqueous solvent onto the fabric to which the ink has been applied.

[10] The image forming method according to [8] or [9], wherein the anionic water-dispersible resin includes a (meth) acrylic resin or a urethane resin.

[11] The image forming method according to [9], wherein at least one of the ink and the second treatment liquid further includes a crosslinking agent.

[12] The image forming method according to any one of [1] to [11], wherein the aggregating agent contains a polyvalent metal salt or a compound having a cationic group.

[13] The image forming method according to [12], wherein the compound having a cationic group includes a cationic resin.

### DETAILED DESCRIPTION OF EMBODIMENTS

Hereinafter, one or more embodiments of the present invention will be described with reference to the drawings. However, the scope of the invention is not limited to the disclosed embodiments.

The above described block copolymer containing the two hydrophilic blocks A disposed at both ends of the molecule of the block copolymer and the hydrophobic block B disposed between the hydrophilic blocks A as a pigment-dispersing agent has a hydrophilic portion and a hydrophobic portion as blocks, and thus easily interacts with a cationic aggregating agent attached to the fabric at multiple points and has a strong binding force as compared to a random copolymer. Therefore, the ink containing the block copolymer can form an image having high friction fastness even on a fabric in a dry state treated off-line.

On the other hand, a new problem has been found that an image obtained using an ink containing the block copolymer tends to have density unevenness and color unevenness. This is presumed to be because the pigment dispersion containing the block copolymer aggregates before the liquid droplets of the ink sufficiently wet and spread on the fabric due to the strong binding force between the block copolymer and the cationic aggregating agent on the fabric.

In contrast, as a result of intensive studies, the present invention has found that when a silicone acrylic resin is further contained in the ink containing the block copolymer, density unevenness and color unevenness can be suppressed. That is, when the ink contains the silicone acrylic resin, the ink easily wets and spreads. Therefore, it is considered that since the pigment dispersion containing the block copolymer can be rapidly aggregated while rapidly wetting and spreading the droplets of the ink on the fabric, the density unevenness or the color unevenness can be reduced.

In addition, the silicone acrylic resin having siloxane as a main chain can make the dispersion stability of the ink and the ejection property by the inkjet less likely to be deteriorated, compared to a resin having a silicone-based surfactant or an acrylic polymer as a main chain.

That is, an image forming method according to an embodiment of the present invention includes 1) a step of preparing a fabric in a dry state to which a cationic aggregating agent is attached (hereinafter, also referred to as a treated fabric), and 2) a step of applying an ink including a pigment, an anionic block copolymer, a silicone acrylic resin, and water onto the fabric by a inkjet method.

Hereinafter, in the description of the image forming method, the ink used in the image forming method, the treatment liquid (first treatment liquid) for preparing the treated fabric, and the second treatment liquid will be described.

### 1. Ink, First Treatment Liquid, and Second Treatment Liquid

### 1-1. Ink

The ink used in the present embodiment is a water-based ink and contains a pigment, an anionic block copolymer, a silicone acrylic resin, and an aqueous solvent.

### 1-1-1. Pigment

The pigment is not particularly limited, and examples thereof include organic pigments or inorganic pigments having the following numbers described in the Color Index.

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, and Pigment Orange 13, 16, 20, 36.

Examples of blue or cyan pigments include Pigment Blue 1, 15, 15:1, 15:2, 15:3, 15:4, 15:6, 16, 17-1, 22, 27, 28, 29, 36, and 60.

Examples of green pigments include Pigment Green 7, 26, 36, and 50.

Examples of yellow pigments include Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of black pigments include Pigment Black 7, 28, and 26.

Examples of commercially available products of the pigment include the following: Chromofine Yellow 2080, 5900, 5930, AF-1300, 2700 L, Chromofine Orange 3700 L, 6730, Chromofine Scarlet 6750, Chromofine Magenta 6880, 6886, 6891N, 6790, 6887, Chromofine Violet RE, Chromofine Red 6820, 6830, Chromofine Blue HS-3, 5187, 5108, 5197, 5085 N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seikafast Yellow, 10GH, A-3, 2035, 2054, 2200, 2270, 2300, 2400 (B), 2500, 2600, ZAY-260, 2700 (B), 2770, Seikafast Red 8040, C405 (F), CA120, LR-116, 1531B, 8060R, 1547, ZAW-262, 1537B, GY, 4R-4016, 3820, 3891, ZA-215, Seikafast Carmine 6B1476T-7, 1483LT, 3840, 3870, Seikafast Bordeaux 10B-430, Seikalight Rose R40, Seikalight Violet B800, 7805, Seikafast Maroon 460N, Seikafast Orange 900, 2900, Seikalight blue C718, A612, Cyanine Blue 4933M, 4933GN-EP, 4940, 4973 (manufactured by Dainichiseika Chemicals Co., Ltd.); KET Yellow 401, 402, 403, 404, 405, 406, 416, and 424, KET Orange 501, KET Red 301, 302, 303, 304, 305, 306, 307, 308, 309, 310, 336, 337, 338, and 346, KET Blue 101, 102, 103, 104, 105, 106, 111, 118, 124, and KET Green 201 (manufactured by Dainippon Ink and Chemicals, Inc); Colortex Yellow 301, 314, 315, 316, P-624, 314, U10GN, U3GN, UNN, UA-414, U263, Finecol Yellow T-13, T-05, Pigment Yellow1705, Colortex Orange 202, Colortex Red101, 103, 115, 116, D3B, P-625, 102, H-1024, 105C, UFN, UCN, UBN, U3BN, URN, UGN, UG276, U456, U457, 105C, USN, Colortex Maroon601, Colortex BrownB610N, Colortex Violet600, Pigment Red 122, Colortex Blue 516, 517, 518, 519, A818, P-908, 510, Colortex Green402, 403, Colortex Black 702, U905 (manufactured by Sanyo Shiki Co., Ltd.); Lionol Yellow1405G, Lionol Blue FG7330, FG7350, FG7400G, FG7405G, ES, and ESP-S (manufactured by Toyo Ink Mfg. Co., Ltd);

Toner Magenta E02, Permanent RubinF6B, Toner Yellow HG, Permanent Yellow GG-02, and Hostapeam BlueB2G (manufactured by Hoechst Industries, Ltd); Novoperm P-HG, Hostaperm Pink E, and Hostaperm Blue B2G (manufactured by Clariant); and carbon black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, and CF9 (manufactured by Mitsubishi Chemical Corporation).

### Self-Dispersible Pigment

The pigment may be a self-dispersible pigment. The self-dispersible pigment is obtained by modifying the surface of a pigment particle with a group having a hydrophilic group. The self-dispersible pigment includes a pigment particle and a hydrophilic group bonded to the surface of the pigment particle.

Examples of the hydrophilic group include a carboxy group, a sulfonic acid group, and a phosphorus-containing group. Examples of the phosphorus-containing group include a phosphoric acid group, a phosphonic acid group, a phosphinic acid group, a phosphite group, and a phosphate group.

Examples of commercially available products of self-dispersible pigments include Cab-O-Jet (registered trademark) 200K, 250C, 260M, and 270 V (sulfonic acid group-containing self-dispersible pigments) manufactured by Cabot Corporation. Other examples of commercially available self-dispersible pigments include Cab-O-Jet (registered trademark) 300K (carboxylic acid group-containing self-dispersible pigments) and Cab-O-Jet (registered trademark) 400K, 450C, 465M, 470 V, and 480 V (phosphoric acid group-containing self-dispersible pigments) available from Cabot Corporation.

The content of the pigment is not particularly limited, but is preferably in a range of 1.5% by mass or more and 15% by mass or less with respect to the ink. When the content of the pigment is 1.5% by mass or more, a high-density image is easily formed. When the content of the pigment is 15% by mass or less, the viscosity of the ink does not become excessively high, and thus the ejection stability is less likely to be impaired. For the same reason, the content of the pigment is more preferably 5% by mass or more and 15% by mass or less with respect to the ink.

### 1-1-2. Anionic Block Copolymer

The anionic block copolymer can function as a pigment-dispersing agent. The pigment-dispersing agent is attached to the surface of the pigment and facilitates the dispersion of the pigment in water. A pigment to which a pigment-dispersing agent is attached and which is dispersed in a dispersion medium (such as water) is referred to as a pigment dispersion.

The anionic block copolymer is a copolymer containing a hydrophilic block A and a hydrophobic block B, preferably a copolymer containing two hydrophilic blocks A arranged at both ends of the molecule thereof and a hydrophobic block B arranged between the two hydrophilic blocks A, and more preferably an ABA-type block copolymer composed of two hydrophilic blocks A and a hydrophobic block B arranged between thehydrophilic blocks A.

The hydrophilic block A includes a site that interacts or reacts with the above-described cationic aggregating agent. The interaction includes electrical bonding, bonding by hydrogen bonding, and the like, and is preferably electrical bonding. The hydrophobic block B includes a site adsorbing to the pigment.

The random copolymer is less likely to interact or react with the aggregating agent because the random copolymer does not have a block containing many sites interacting or reacting with the aggregating agent.

On the other hand, the copolymer including the hydrophilic block A and the hydrophobic block B has a block including many sites which interact or react with the aggregating agent, and thus the interaction or the reaction with the aggregating agent easily occurs. In particular, a copolymer (for example, a block copolymer of an ABA type or the like) including two hydrophilic blocks A disposed at both ends of the molecule and a hydrophobic block B disposed between the two hydrophilic blocks A includes a block including many sites which interact or react with the aggregating agent at both ends of the molecule. As described above, since the blocks are present in at least two places of both ends of the molecule, there are many binding points capable of binding to a fabric, and the binding to the fabric is more likely to be strong. Thus, the adhesion to a fabric is improved, and the friction fastness tends to be higher. In addition, since the copolymer can be intermittently bonded to the fabric at a plurality of bonding points, the fabric is less likely to be hardened than in the case where the copolymer is continuously bonded to the fabric at one bonding point.

The “hydrophilic block A” is an anionic block which increases the affinity with the aqueous solvent contained in the pigment ink and includes a site which interacts or reacts with the cationic aggregating agent attached to the fabric, and refers to a block having a higher affinity with water among the blocks constituting the copolymer. The number of hydrophilic blocks is preferably two.

The hydrophilic block A includes a constituent unit derived from a monomer having a hydrophilic anionic functional group (hereinafter, referred to as a “hydrophilic monomer”). Examples of the hydrophilic anionic functional group include a hydroxyl group, a carboxyl group, and a sulfonic acid group.

The hydrophilic monomer constituting the hydrophilic block A includes a monomer containing a hydrophilic anionic functional group and an unsaturated double bond, and the like, and examples thereof include the following: (meth) acrylic acid, unsaturated polyvalent carboxylic acids such as maleic acid, and monomers containing a carboxy group or an acid anhydride group such as maleic anhydride; monomers containing sulfonic acid groups, such as styrenesulfonic acid and 4-(methacryloyloxy) butylsulfonic acid; and the like. Of these, the hydrophilic monomer is preferably (meth) acrylic acid from the viewpoint of imparting moderate water solubility to the hydrophilic block A.

The content ratio of the constituent unit derived from a hydrophilic monomer in the hydrophilic block A is not limited as long as it is greater than the content ratio of the constituent unit derived from a hydrophilic monomer in the hydrophobic block B. To be specific, the content ratio of the constituent unit derived from the hydrophilic monomer in the hydrophilic block A is preferably 5% by mass or more with respect to 100% by mass of the hydrophilic block A. When the content ratio of the constituent unit derived from the hydrophilic monomer is 5% by mass or more, not only the dispersibility into an aqueous solvent is more likely to be increased, but also the constituent unit is more likely to interact or react with a cationic resin, and therefore, the friction fastness is more likely to be increased. From the same viewpoint, the content ratio is more preferably 10% by mass or more and 40% by mass or less.

The hydrophilic block A may further include a constituent unit derived from a monomer other than the hydrophilic monomer. Examples of the other monomers include methyl (meth)acrylic acid, and alkyl (meth)acrylic acids such as tert-butyl (meth)acrylic acid. Among these, C2 or higher alkyl esters such as (meth)acrylic acid butyl ester are preferred. This is because the anionic block copolymer has a low glass transition temperature and the fabric does not tend to become hard. However, the other monomers do not include hydrophobic monomers which will be described below.

The “hydrophobic block B” is a site adsorbing to the pigment, and refers to a block having a smaller affinity with the aqueous solvent contained in the ink among the blocks constituting the copolymer. The number of the hydrophobic blocks B is preferably one.

The hydrophobic block B includes a constituent unit derived from a monomer having a hydrophobic functional group (hereinafter, referred to as a “hydrophobic monomer”). Examples of the monomer having a hydrophobic functional group include monomers containing an aromatic ring group or an alicyclic hydrocarbon group.

Examples of the monomer containing an aromatic ring group include the following: (meth)acrylic acids having an aromatic ring group, such as benzyl (meth)acrylic acid, phenyl (meth)acrylic acid, and phenoxyethyl (meth)acrylic acid; and aromatic monomers such as styrene, α-methylstyrene, 4-methylstyrene, 2-methylstyrene, 3-methylstyrene, 4-methoxystyrene, 2-hydroxymethylstyrene, and 1-vinylnaphthalene.

A monomer having an aromatic ring group having 6 or more and 15 or less carbon atoms is preferable.

Examples of the monomer having an alicyclic alkyl group include the following: (meth)acrylates having an alicyclic alkyl group, such as cyclohexyl (meth)acrylate, methylcyclohexyl (meth)acrylate, cyclododecyl (meth)acrylate, bornyl (meth)acrylate, isobornyl (meth)acrylate, dicyclopentanyl (meth)acrylate, dicyclopentenyl (meth)acrylate, and dicyclopentenyloxyethyl (meth)acrylate.

A monomer having an alicyclic alkyl group having 6 or more and 15 or less carbon atoms is preferable.

Of these, a monomer having an aromatic ring group having 6 or more and 15 or less carbon atoms, such as styrene, is preferable as the hydrophobic monomer from the viewpoint of improving the adsorptivity to a pigment.

The content ratio of the constituent unit derived from the hydrophobic monomer in the hydrophobic block B is preferably 80% by mass or more based on the hydrophobic block B. When the content ratio is 80% by mass or more, the adsorptivity to a pigment is more likely to be increased. From the same viewpoint, the content ratio is more preferably more than 90% by mass, and even more preferably 95% by mass or more.

The hydrophobic block B may further include a constituent unit derived from another monomer other than the hydrophobic monomer. Examples of the other monomers include the other monomers described above and the hydrophilic monomers described above. Provided that when the hydrophobic block B contains a constituent unit derived from a hydrophilic monomer, the content ratio of the constituent unit derived from the hydrophilic monomer in the hydrophobic block B is less than that in the hydrophilic block A. Specifically, the content of the constituent unit derived from a hydrophilic monomer is preferably 20% by mass or less, more preferably less than 10% by mass, and still more preferably 5% by mass or less, with respect to the hydrophobic block B. That is, of the two blocks, i.e., the hydrophilic block A and the hydrophobic block B, the content of the constituent unit derived from the hydrophilic monomer (the number of moles of the hydrophilic functional group) is smallest in the hydrophobic block B.

The content of the hydrophobic block B in the anionic block copolymer is preferably 20% by mass to 80% by mass and more preferably is 20% by mass or more and 50% by mass or less with respect to the entire block copolymer. When the content is 20% by mass or more, since the content of the hydrophilic block A is small (or the molecular weight is small), bridging aggregation is more easily suppressed. When the content is 80% by mass or less, the content of the hydrophilic block A is large (or the molecular weight is large), and therefore, the affinity for aqueous solvents is more easily enhanced.

When the hydrophilic block is represented by A and the hydrophobic block is represented by B, examples of the structure of the anionic block copolymer include an AB type, an ABA type, and an ABABA type. In particular, the block copolymer is preferably an ABA-type block copolymer composed of two hydrophilic blocks A disposed at both ends of the molecule and a hydrophobic block B disposed therebetween.

The types and composition ratios of the monomers of the plurality of blocks A included in the block copolymer may be the same as or different from each other. In addition, in a case where the block copolymer includes a plurality of blocks B, the types and composition ratios of the monomers of the plurality of blocks B may be the same as or different from each other. In particular, the two hydrophilic blocks A preferably have the same monomer composition.

The weight average molecular weight of the anionic block copolymer is preferably 5000 or more and 70000 or less, more preferably 7000 or more and 30000 or less. As the weight average molecular weight is larger, the dispersibility of the pigment in the aqueous solvent is more easily enhanced, and as the weight average molecular weight is smaller, bridging aggregation between dispersions of the pigments, to which the anionic pigment-dispersing agents are attached, (which may also be referred to as between the pigments) is more easily suppressed. The weight average molecular weight of the anionic block copolymer can be measured by gel permeation chromatography in terms of polystyrene.

The molecular weight distribution (PDI) (weight average molecular weight (Mw) of block copolymer)/(number-average molecular weight (Mn) of block copolymer) is preferably 2.0 or less, and more preferably 1.8 or less. A lower PDI means a narrower and more uniform molecular weight distribution, resulting in better dispersibility.

The acid number of the anionic block copolymers is, for example, preferably 40 mgKOH/g or more and 400 mgKOH/g or less, more preferably 40 mgKOH/g or more and 300 mgKOH/g or less, still more preferably 40 mgKOH/g or more and 190 mgKOH/g or less. When the acid value is 40 mgKOH/g or more, the hydrophilicity of the pigment-dispersing agent can be increased to further increase the dispersibility of the pigment. Furthermore, when the acid number is 400 mgKOH/g or less, the hydrophilicity of the pigment-dispersing agent can be more inhibited from excessively increasing, and the adsorptivity to pigments can be more hardly impaired. The acid number can be measured according to the measurement method of JIS K0070:1992.

The content of the anionic block copolymer is preferably 10% by mass or more and 50% by mass or less, more preferably 20% by mass or more and 40% by mass or less with respect to the pigment. When the content is 10% by mass or more, the dispersibility of the pigment in the pigment dispersion can be further enhanced. In addition, when the content of the pigment-dispersing agent is 50% by mass or less, it is possible to further suppress an increase in viscosity of the pigment-dispersing agent due to an excessive content of the pigment dispersant.

The method for synthesizing the anionic block copolymer is not particularly limited, but the anionic block copolymer can be obtained, for example, by sequentially polymerizing vinyl monomers that form the blocks by a living radical polymerization method.

### 1-1-3. Silicone Acrylic Resin

The silicone acrylic resin allows an ink to easily wet and spread on a fabric. The silicone acrylic resin may be a copolymer including a constituent unit X derived from polyorganosiloxane having a radically polymerizable group and a constituent unit Y derived from (meth)acrylic acid ester. Examples of the radically polymerizable group include a vinyl group, an allyl group, a (meth)acryloxy group, and a mercapto group. The silicone acrylic resin can be present in a state of being dispersed as resin particles in an aqueous medium.

The copolymer is preferably, for example, a graft copolymer in which a (meth)acrylic acid ester or the like is graft-polymerized onto a polymer including a constituent unit derived from the polyorganosiloxane having the radically polymerizable group. Such a graft copolymer has a structure in which the polyorganosiloxane portion serves as a trunk portion and the (meth)acrylic acid ester or the like serves as a branch portion, and therefore, for example, in the case of using an ink containing an acrylic resin, the graft copolymer is more easily compatible with the acrylic resin, which is preferable. Note that the form of the copolymerization is not limited to graft copolymerization, and may be random copolymerization or block copolymerization. However, in the case of block copolymerization, it is different from the above-described anionic block copolymer.

The silicone acrylic resin may have an anionic group. Examples of the anionic group include a carboxy group, a sulfonic acid group and a phosphonic acid group.

Examples of the polyorganosiloxane having a radically polymerizable group include polyorganosiloxanes represented by the following Formula (1).

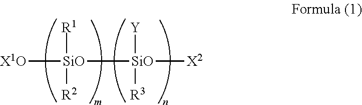

In Formula (1), R¹, R² and R³ each independently represent a hydrocarbon group having 1 to 10 carbon atoms.

In Formula (1), Y is a radically polymerizable group selected from the group consisting of a vinyl group, an allyl group, and a γ-(meth)acryloxypropyl group.

In Formula (1), X¹ and X² are independently a hydrogen atom, an alkyl group having 1 to 10 carbon atoms, or a group represented by −SiR⁴R⁵R⁶. M is an integer of 1 or more and 10000 or less. N is an integer of 1 or more. The siloxane chain may be branched.

In the formula −SiR⁴R⁵R⁶, R⁴ and R⁵ each independently represent a hydrocarbon group having 1 to 10 carbon atoms. R⁶ is a radically polymerizable group selected from the group consisting of a vinyl group, an allyl group, and a γ-(meth)acryloxypropyl group, or a hydrocarbon group having 1 or more and 10 or less carbon atoms.

Examples of the other polymerizable monomers include (meth)acrylic acid esters. In the present specification, (meth)acryl represents acryl, methacryl, or both of them.

The (meth)acrylic acid ester is an alkyl ester, a hydroxyalkyl ester, or an alkoxyalkyl ester of (meth)acrylic acid. Examples of the (meth)acrylic acid ester include methyl (meth)acrylate, ethyl (meth)acrylate, isopropyl (meth)acrylate, N-propyl (meth)acrylate, N-butyl (meth)acrylate, and isobutyl (meth)acrylate. Other examples of the (meth)acrylic acid ester include 2-ethylhexyl (meth)acrylate, isooctyl (meth)acrylate, N-octyl (meth)acrylate, and 2-hydroxyethyl (meth)acrylate. Among these, methyl methacrylate and 2-hydroxyethyl methacrylate are preferable.

The content of the constituent unit X derived from the polyorganosiloxane having a radically polymerizable group in the silicone acrylic resin is preferably 50% by mass or more, more preferably 60% by mass or more and 99% by mass or less, and more preferably 80% by mass or more and 99% by mass or less with respect to the sum of the amounts of the constituent unit X derived from the polyorganosiloxane having a radically polymerizable group and the constituent unit Y derived from a (meth)acrylic acid ester in the silicone acrylic resin. When the content of the constituent unit X is 50% by mass or more, the effect of improving wettability derived from the polysiloxane is more easily obtained. When the content of the constituent unit X is 99% by mass or less, the content of the constituent unit Y derived from a (meth)acrylic acid ester is sufficient, and for example, the affinity with a water-dispersible resin (for example, an acrylic resin) which may be contained in the ink or the second treatment liquid is more likely to be further enhanced. Note that the sum of the amounts of the constituent unit X and the constituent unit Y in the silicone acrylic resin may be 50% by mass or more, and may be 100% by mass, with respect to the total amount of all constituent units of the silicone acrylic resin.

The silicone acrylic resin may further include a constituent unit derived from another polymerizable monomer other than the above-described monomers. Examples of other polymerizable monomers include ethylenically unsaturated carboxylic acids such as (meth)acrylic acid, and styrenes. For example, from the viewpoint of exhibiting anionic properties, the silicone acrylic resin may further include a constitutional unit derived from an ethylenically unsaturated carboxylic acid such as (meth)acrylic acid.

The weight average molecular weight of the silicone acrylic resin is not particularly limited, but is, for example, preferably 1000 or more and 500000 or less, more preferably 1000 or more and 100000 or less, further more preferably 1000 or more and 50000 or less. When the weight average molecular weight is 1000 or more, density unevenness and color unevenness can be further suppressed because wet spreading of an ink can be further accelerated. When the weight average molecular weight is 500000 or less, the viscosity of the ink can be further reduced, and thus the ejection stability and texture can be more satisfactorily maintained. The weight average molecular weight of the silicone acrylic resin can be measured by gel permeation chromatography in terms of polystyrene.

The graft copolymerization can be performed by a known method. For example, graft copolymerization can be performed by emulsifying and dispersing a polyorganosiloxane represented by Formula (1) and a copolymerizable compound such as a (meth)acrylic acid ester in water, and polymerizing the mixture in the presence of a radical polymerization initiator.

Examples of commercially available silicone acrylic resins include Shaline LC190, Shaline R-170, R170S, Shaline FE-230N, FE-502, and R-170BX (manufactured by Nissin Chemical Industry Co., Ltd).

The content of the silicone acrylic resin with respect to the ink is preferably from 0.1% by mass to 10% by mass, and more preferably from 0.2% by mass to 3.0% by mass. When the content is 0.1% by mass or more, the ink can more easily wet-spread on the fabric. Thus, while the ink is allowed to wet-spread, the aggregation of the pigment by the anionic block copolymer can be further promoted, so that the density unevenness and the color unevenness can be further reduced. In addition, when the content of the silicone acrylic resin is less than or equal to 10% by mass, it is possible to make ejection stability and texture less likely to deteriorate.

From the same viewpoint as described above, the mass ratio of the content of the silicone acrylic resin to the content of the anionic block copolymer is preferably ⅓ or more and 10/1 or less, and more preferably ½ or more and 5/1 or less.

Furthermore, when the ink further contains a water-dispersible resin other than the anionic block copolymer, the mass ratio of the content of the silicone acrylic resin with respect to the sum of the amounts of the silicone acrylic resin and the water-dispersible resin is preferably 1/100 or more and ½ or less, and more preferably 1/50 or more and 3/10 or less. When the mass ratio is 1/50 or more, the ink can be made to wet and spread more easily, so that density unevenness and color unevenness can be further suppressed. When the mass ratio is 3/10 or lower, a decrease in texture can be further suppressed while friction fastness is further enhanced.

### 1-1-4. Aqueous Solvent

The aqueous solvent contains water, and preferably further contains a water-soluble organic solvent. By further including a water-soluble organic solvent, it is possible to further increase the ejection stability by inkjet.

The water-soluble organic solvent is not particularly limited as long as it is compatible with water, and examples thereof include the following: polyhydric alcohols (e.g., dihydric alcohols such as ethylene glycol, diethylene glycol, triethylene glycol, polyethylene glycol, propylene glycol, dipropylene glycol, tripropylene glycol, and polypropylene glycol, and trihydric or higher hydric alcohols such as glycerin, trimethylolpropane, and hexanetriol); polyhydric alcohololyhydric alcohol ethers (e.g., ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, propylene glycol monomethyl ether, and propylene glycol monoethyl ether); monohydric alcohols (e.g., methanol, ethanol, propanol, pentanol, hexanol, cyclohexanol, and benzyl alcohol); amines (e.g., ethanolamine, N-ethyldiethanolamine, morpholine, N-ethylmorpholine, ethylenediamine, diethylenediamine, and triethylenetetramine); amides (e.g., formamide, N,N-dimethylformamide, and N,N-dimethylacetamide); heterocycles (e.g., 2-pyrrolidone, N-methyl-2-pyrrolidone, N-cyclohexyl-2-pyrrolidone, 2-oxazolidone, 1,3-dimethyl-2-imidazolidine), sulfoxides (e.g., dimethyl sulfoxide); and sulfones (e.g., sulfolane).

In addition, from the viewpoint of further enhancing ejection stability by inkjet, the water-soluble organic solvent preferably includes a water-soluble organic solvent having a boiling point of 180° C. or more, preferably 190° C. or more, and more preferably 200° C. or more. Examples of the water-soluble organic solvent having a boiling point of 180° C. or higher include dihydric alcohols and trihydric or higher hydric alcohols. Examples of the dihydric alcohols include ethylene glycol (boiling point: 197° C.), 1,3-butanediol (boiling point: 208° C.), 1,6-hexanediol (boiling point: 223°° C.), and polypropylene glycol. Examples of trihydric or higher alcohols include glycerin (boiling point: 290° C.) and trimethylolpropane (boiling point: 295° C.).

The content of the water-soluble organic solvent in the ink is, for example, preferably 20% by mass or more and 70% by mass or less, more preferably 30% by mass or more and 60% by mass or less with respect to the ink.

Similarly, the content of the water in the ink is, for example, preferably 20% by mass or more and 70% by mass or less, more preferably 30% by mass or more and 60% by mass or less with respect to the ink.

### 1-1-5. Other Ingredients

The ink may further contain components other than those described above, as necessary. Examples of other components include a water-dispersible resin different from the block copolymer described above, a crosslinking agent, and other additives.

### Water-Dispersible Resin

From the viewpoint of further improving the fixability of the pigment to a fabric, it is preferable that the ink further contains a water-dispersible resin other than the above-described block copolymer. Such a water-dispersible resin is contained as resin particles in the ink, and can have a function of further increasing the fixability of the pigment or the like to the fabric. The water-dispersible resin is preferably an anionic water-dispersible resin containing an anionic functional group. Examples of the anionic functional group include a hydroxyl group, a carboxyl group, and a sulfonic acid group.

Examples of the anionic water-dispersible resin include resin such as anionic urethane resin, butadiene resin, (meth)acrylic resin, and polystyrene resin. Among these, anionic urethane resin and anionic (meth)acrylic resin are preferable. These resins are bonded to the anionic block copolymer by an intermolecular hydrogen bond, and the adhesion to a fabric is more easily enhanced and the friction fastness is more easily enhanced.

Examples of the anionic (meth)acrylic resin include (meth)acrylic acid ester copolymers, styrene-(meth)acrylic copolymers, silicone-(meth)acrylic copolymers, acrylic-modified fluororesins, and the like, each of which contains a constitutional unit derived from (meth)acrylic acid, styrene sulfonic acid, hydroxystyrene, or the like.

Examples of the anionic styrene-(meth)acrylic copolymer include a styrene-(meth)acrylic acid copolymer and a styrene-(meth)acrylic acid-(meth)acrylic acid ester copolymer, which include a constitutional unit derived from (meth)acrylic acid, styrenesulfonic acid, hydroxystyrene, or the like. Examples of the (meth)acrylic acid ester include benzyl (meth)acrylate, cyclohexyl (meth)acrylate, methyl (meth)acrylate, ethyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexylcarbitol (meth)acrylate, phenol EO-modified (meth)acrylate, isobornyl (meth)acrylate, dicyclopentenyl (meth)acrylate, dicyclopentanyl (meth)acrylate, dicyclopentenyloxyethyl (meth)acrylate and the like.

The anionic urethane resin is a polymer obtained by reacting a polyol and a polyisocyanate, and contains a carboxyl group, a sulfonic acid group, and the like in a part or all of the polyol and the polyisocyanate. Examples of polyols include polypropylene glycol, polyethylene glycol, polytetramethylene glycol, poly(ethylene adipate), poly(diethylene adipate), poly (propylene adipate), poly (tetramethylene adipate), poly(hexamethylene adipate), poly-ε-caprolactone, poly(hexamethylene carbonate), silicone polyols, and the like. Examples of the isocyanate include tolylene diisocyanate, 4,4-diphenylmethane diisocyanate, xylylene diisocyanate, naphthalene diisocyanate, hexamethylene diisocyanate, hydrogenated tolylene diisocyanate, hydrogenated 4,4-diphenylmethane diisocyanate, isophorone diisocyanate, tetramethyl xylylene diisocyanate and the like.

The Tg of the water-dispersible resin is not particularly limited, but is preferably low from the viewpoint that the fabric is less likely to become hard even after image formation and the texture is easily maintained. The Tg of the anionic water-dispersible resin can be, for example, −30° C. or more and 100° C. or less, preferably 10° C. or more and 50° C. or less.

The acid value of the water-dispersible resin is not particularly limited, but is preferably 44 mgKOH/g or more, and more preferably 60 mgKOH/g or more, for example, from the viewpoint of enhancing dispersion stability. The upper limit of the acid number may be, for example, 110 mgKOH/g. The acid value can be measured by the same method as described above.

The average particle size of the water-dispersible resins is not particularly limited, but is preferably 300 nm or smaller, and more preferably 130 nm or smaller, from the viewpoint of making nozzle clogging of an inkjet head less likely to occur. The average particle diameter of the anionic water-dispersible resin can be measured by laser diffraction scattering particle size distribution measurement.

The content of the water-dispersible resin is preferably 1% by mass or more and 15% by mass or less with respect to the ink. When the content of the anionic water-dispersible resin is 1% by mass or more, the viscosity of the ink is more likely to be moderately increased, and thus not only the ejection stability can be further increased, but also the adhesion of the obtained image to a fabric and the abrasion resistance are more likely to be increased. When the content of the water-dispersible resin is 15% by mass or less, the viscosity of the pigment ink does not become excessively high, and thus nozzle clogging or the like is less likely to occur. For the same reason, the content of the anionic water-dispersible resin is more preferably 2% by mass or more and 10% by mass or less with respect to the ink.

### Crosslinking Agent

When the ink contains the anionic water-dispersible resin, or when the second treatment liquid is used, at least one of the ink and the second treatment liquid may further contain a crosslinking agent for crosslinking the anionic water-dispersible resin.

The crosslinking agent is preferably a compound having, in the molecule, at least two functional groups that react with a crosslinkable group (a hydroxyl group, a carboxyl group, or a ketone group) of the anionic water-dispersible resin. Examples of the crosslinking group which reacts with a hydroxyl group include an isocyanate group and a blocked isocyanate group. Furthermore, examples of the crosslinking group that reacts with a carboxy group include an oxazolyl group, an aziridine group, and a carbodiimide group. Furthermore, examples of the crosslinking group which reacts with a ketone group include a hydrazide group.

Specifically, examples of the crosslinking agent that reacts with a hydroxyl group include FIXER N (a blocked isocyanate-based crosslinking agent, manufactured by Matsui Shikiso Chemical Co., Ltd). Examples of the crosslinking agent that reacts with a carboxy group include FIXER F (an aziridine-based crosslinking agent, manufactured by Matsui Color Chemical Industry Co., Ltd). Examples of the crosslinking agent that reacts with a ketone group include adipic acid dihydrazide (ADH, hydrazine-based crosslinking agent).

For example, the crosslinking agent contained in the ink is most preferably adipic acid dihydrazide, and the anionic water-dispersible resin having a crosslinkable group that reacts with it is preferably a water-dispersible resin containing a structural unit derived from diacetone acrylamide (DAAM). This is because crosslinking can be performed at room temperature while enabling long-term storage at room temperature.

### Other Additives

The ink may further contain an additive other than those described above, as necessary. Examples of the additive include a surfactant, a preservative, and an antifungal agent.

The surfactant can lower the surface tension of the ink and increase the wettability of the ink to the fabric. The type of surfactant is not particularly limited, and may be, for example, an acetylene glycol-based surfactant, a silicone-based surfactant, or a fluorine-based surfactant.

Examples of the preservative or antifungal agent include aromatic halogen compounds (e.g., Preventol CMK), methylene dithiocyanate, halogen-containing nitrogen-sulfur compounds, 1,2-benzisothiazolin-3-one (e.g., PROXEL GXL), and the like.

### 1-2. First Treatment Liquid

### 1-2-1. Cationic Aggregating Agent

The cationic aggregating agent aggregates the pigment dispersion containing the anionic block copolymer contained in the ink. The aggregation by the cationic aggregating agent utilizes an electrical action.

Examples of the cationic aggregating agent that causes aggregation by an electrical action include compounds having a cationic group, and polyvalent metal salts. These cationic aggregating agents can interact with the anionic block copolymer contained in the pigment dispersion in the ink.

Examples of the cationic group in the compound having a cationic group include a secondary amino group, a tertiary amino group, and a quaternary ammonium salt group. Examples of the compound having a cationic group include cationic resins and cationic surfactants, with cationic resins being preferred.

Examples of the cationic resin include a cationic urethane resin, a cationic olefin resin, and a cationic alkylamine resin. Examples of commercially available products include MPT-60 (manufactured by Mitsubishi Pencil Co., Ltd), Unisence KHE-100L (manufactured by Senka Corporation), and MZ477 (urethane resin, manufactured by Takamatsu Oil & Fat Co., Ltd). Among them, preferred are cationic alkylamine resin MPT-60 and Unisence KHE100L (manufactured by Senka Corporation). According to this, an interaction with the anionic block copolymer can be more easily generated.

The polyvalent metal salt may be a water-soluble compound having a divalent or more polyvalent metal ion and an anion to be bonded thereto. Examples of the polyvalent metal ion include divalent metal ions such as Ca²⁺, Cu²⁺, Ni²⁺, Mg²⁺, Zn²⁺, and Ba²⁺, and trivalent metal ions such as Al³⁺, Fe³⁺, and Cr³⁺. Examples of the anion include Cl⁻, I⁻, Br⁻, SO₄²⁻, ClO³⁻, NO³⁻, HCOO⁻, and CH₃COO⁻. Examples of such polyvalent metal salts include zinc acetate dihydrate, magnesium nitrate, calcium chloride, magnesium chloride, aluminum chloride, magnesium sulfate, and metal salts such as calcium salts, and magnesium salts, nickel salts, and aluminum salts of organic acids such as acetic acid. Among these, calcium salts and magnesium salts are preferable, and calcium nitrate and calcium chloride are preferable.

Among these, a compound having a cationic group is preferable, and a cationic resin is more preferable. In particular, a fabric treated with the first treatment liquid containing a cationic resin has a higher effect of aggregation of the pigment dispersion than a fabric treated with a polyvalent metal salt or the fabric treated with an organic acid. Therefore, image density unevenness and color unevenness are more likely to occur due to the use of the above-described anionic block copolymer. Even in such a case, the density unevenness and the color unevenness can be suppressed by using the ink containing the silicone acrylic resin described above in the present embodiment.

The cation value of the cationic resin is preferably 0.5 mmol/g or more and 10.0 mmol/g or less, and more preferably 1.2 mmol/g or more and 6.2 mmol/g or less. When the cation value is 0.5 mmol/g or more, the aggregation reaction proceeds more easily, and the friction fastness can be further enhanced. When the cation value is 10.0 mmol/g or less, an excessive aggregation reaction is less likely to proceed.

The cation value of the cationic resin is a value measured by the following colloidal titration method.
(1) An aqueous dispersion of a resin is prepared.
(2) Toluidine blue is added as an indicator.
(3) PVSK (Potassium polyvinyl sulfate) solution is used as the titrant. The end point is reached when the discoloration of the dispersion liquid changes from blue to red.
(4) The cation value is calculated from the resin amount (solid content) in the aqueous dispersion and the titration amount of the PVSK solution.

The content of the cationic aggregating agent in the first treatment liquid is preferably 1.0% by mass or more and 20% by mass or less, and more preferably 2.0% by mass or more and 10% by mass or less. When the content is 2.0% by mass or more, the aggregation of the pigment dispersion can be further promoted. In addition, by controlling the content of the cationic aggregating agent to 10% by mass or less, deterioration of the texture can be prevented more effectively.

### 1-2-2. Aqueous Solvent

The aqueous solvent contains water, and preferably further contains a water-soluble organic solvent.

The content of water in the first treatment liquid is, for example, preferably 20% by mass or more and 70% by mass or less, and more preferably 30% by mass or more and 60% by mass or less, with respect to the first treatment liquid.

The content of the water-soluble organic solvent in the first treatment liquid is, for example, preferably 20% by mass or more and 70% by mass or less, and more preferably 30% by mass or more and 60% by mass or less with respect to the first treatment liquid.

### 1-2-3. Other Components

The first treatment liquid may further include other components in addition to those described above, as necessary. As the other components, the same other additives as those used in the ink can be used.

### 1-3. Second Treatment Liquid

The second treatment liquid includes a water-dispersible resin and an aqueous solvent.

### 1-3-1. Water-Dispersible Resin

The water-dispersible resin may be the same as the silicone acrylic resin and other water-dispersible resins used in ink. Among these, an anionic water-dispersible resin is preferable, and a water-dispersible resin having a Tg of 20° C. is more preferable, from the viewpoint that the texture is less likely to be impaired when combined with the above-described ink.

The content of the water-dispersible resin with respect to the second treatment liquid is preferably 1.0% by mass or more and 20% by mass or less, and more preferably 3.0% by mass or more and 10% by mass or less. When the content is 1.0% by mass or more, the fixability of the pigment to the fabric can be further improved, and the friction fastness can be further improved. Furthermore, when the content of the water-dispersible resins is 20% by mass or less, the texture can be less likely to deteriorate.

### 1-3-2. Aqueous Solvent

The content of the water-soluble organic solvent in the second treatment liquid is, for example, preferably 10% by mass or more and 65% by mass or less and more preferably 20% by mass or more and 45% by mass or less with respect to the second treatment liquid.

Similarly, the content of water in the second treatment liquid is, for example, preferably 30% by mass or more and 85% by mass or less, and more preferably 50% by mass or more and 75% by mass or less with respect to the second treatment liquid.

### 1-3-3. Other Ingredients

The second treatment liquid may further include other components in addition to those described above, as necessary. The other components may be the same as the crosslinking agent and other additives used in the ink.

The ink, the first treatment liquid, and the second treatment liquid described above may be provided as an ink set for inkjet textile printing. For example, an ink set for inkjet textile printing includes at least a first treatment liquid and an ink, and may further include a second treatment liquid.

Next, an image forming method using the above-described ink and the like will be described.

### 2. Image Forming Method

The image forming method includes 1) a step of preparing a fabric in a dry state to which a cationic aggregating agent is attached (hereinafter also referred to as a treated fabric), and 2) a step of applying an ink containing a pigment, an anionic block copolymer, a silicone acrylic resin, and water onto the fabric by an inkjet method.

### 2-1. Step of Providing Treated Fabric

In this step, a fabric in a dry state to which a cationic aggregating agent is attached is prepared. The fabric may be a fabric obtained by applying the first treatment liquid containing the cationic aggregating agent to a fabric and then drying the fabric. A treated fabric subjected to such a treatment may be obtained from another source, or a treated fabric may be prepared by performing the treatment in this step. The term “fabric in a dry state” refers to a state in which the content of the solvent (e.g., an aqueous solvent derived from the treatment liquid) in the treated fabric is preferably equal to or less than that of 5.0 g/m², and more preferably equal to or less than that of 3.0 g/m², and more preferably equal to or less than that of 3.0 g/m². The content of the solvent is a value measured by a weight change before and after drying when the treated fabric is dried at 150° C. for 3 minutes.

In the present embodiment, the treated fabric can be prepared through a step of applying the first treatment liquid described above to the fabric and a step of drying the fabric to which the first treatment liquid has been applied. Hereinafter, each step will be described.

### 2-1-1. Step of Applying First Treatment Liquid

The above-described first treatment liquid is applied to the fabric to attach the cationic aggregating agent to the fabric. As described above, the cationic aggregating agent facilitates aggregation of the pigment dispersion containing the anionic block copolymer contained in the ink.

Examples of types of fibers of the fabric include natural fibers such as cotton, hemp, wool, and silk, and chemical fibers such as rayon, vinylon, nylon, acrylic, polyurethane, polyester, and acetate. The fabric may be any form of these fibers such as a woven fabric, a nonwoven fabric, or a knitted fabric. The fabric may also be a mixed-spun woven fabric or a mixed-spun nonwoven fabric of two or more types of fibers.

The method of applying the first treatment liquid to a fabric is not particularly limited and may be, for example, a pad method, a coating method, a spray method, an inkjet method, or the like. Among these, a spraying method or an inkjet method is preferable, and an inkjet method is more preferable, from the viewpoint of enabling higher-speed image formation by carrying out these methods together with a step of applying an ink described later.

The amount of the treatment liquid applied is not particularly limited, and can be adjusted according to the type of fabric and the amount of ink applied. For example, it is preferable to apply the first treatment liquid such that the mass ratio (P/Q) between the application amount P of the aggregating agent and the application amount Q of the anionic block copolymer which can function as a pigment-dispersing agent in the fabric is 1/1 or more and 10/1 or less. Thus, the pigment dispersion can be more easily aggregated. To be specific, the amount of the aggregating agent to be applied can be, for example in the case of a cationic resin, 0.1 g/m² or more and 1.5 g/m² or less with respect to the treated fabric.

### 2-1-2. Drying Step

Next, the fabric to which the first treatment liquid is applied is dried.

In the present embodiment, the drying is performed until the remaining amount of the aqueous solvent derived from the first treatment liquid on the fabric becomes preferably 20% by mass or less, and more preferably 5% by mass or less, based on the total amount of the aqueous solvent derived from the treatment liquid applied to the fabric. The remaining amount of the aqueous medium in the fabric can be calculated from the weights of the textile before and after the first treatment liquid is applied, and the composition of the first treatment liquid (the content ratio of the aqueous medium).

The drying method is not particularly limited, and the drying may be performed at room temperature or may be performed by heating. The heating method may be a method using a heater, a hot air dryer, a heating roller, or the like, and is preferably a method of heating from both surfaces of the fabric using a hot air dryer and a heater. The drying temperature is not particularly limited as long as it is a temperature at which the aqueous solvent in the treatment liquid can be removed, and can be, for example, 80° C. or more and 180° C. or less.

### 2-2. Step of Applying Ink

Next, the above-described ink is applied by an inkjet method onto the above-prepared fabric to which the cationic aggregating agent has been attached.

The application amount of the ink is not particularly limited, but can be, for example, 5 g/m² or more and 30 g/m² or less (including solvent).

### 2-3. Other Steps

The image forming method according to the present embodiment may further include other steps as necessary. For example, a step of applying a second treatment liquid may be further performed simultaneously with or after the above-described step of applying an ink.

In the step of applying the second treatment liquid, the above-described second treatment liquid is further applied onto the ink applied to the fabric. Thus, the fixability of the pigment to the fabric can be further enhanced, and the friction fastness can be further enhanced.

The method of applying the second treatment liquid is not particularly limited and may be any of a dipping method, a spraying method, and an inkjet method, but is preferably an inkjet method.

The application amount of the second treatment liquid is not particularly limited, and can be, for example, 5.0 g/m² or more and 20.0 g/m² or less (including solvent).

Next, the ink and the second treatment liquid applied onto the fabric may be further dried. The drying method is not particularly limited, and the drying may be performed at room temperature or may be performed by heating. The heating method may be a method using a heater, a hot air dryer, a heating roller, or the like, and is preferably a method of heating from both surfaces of the fabric using a hot air dryer and a heater.

The drying temperature is not particularly limited as long as it is a temperature at which the water-soluble organic solvent and water in the ink can be removed, and can be, for example, 80° C. or more and 180° C. or less. The drying time may be, for example, 1 minute or more and 10 minutes or less, depending on the drying temperature.

### 2-4. Action

As described above, in the present embodiment, the step of applying the first treatment liquid to a fabric, the step of drying the applied first treatment liquid, and the step of applying the ink to the dried textile are performed. As described above, in the image forming method in which the treatment of the fabric with the first treatment liquid is performed off-line, the ink containing the anionic block copolymer and the silicone acrylic resin is used. Thus, even on dry a fabric in a dry state with a cationic aggregating agents attached thereto, the pigment dispersion can be quickly aggregated on the fabric while ink droplets can sufficiently wet and spread on the fabric. Thus, an image with suppressed density unevenness and color unevenness can be formed while having high friction fastness.

Therefore, according to the present invention, it is possible to provide an image forming method capable of forming an image having high friction fastness on a textile while suppressing density unevenness and color unevenness even on a fabric treated off-line.

### EXAMPLES

Hereinafter, the present invention will be specifically described with reference to examples, but the present invention is not limited thereto.

### 1. Preparation of Ink

### 1-1. Preparation of Copolymer (Pigment-Dispersing Agent)

### Preparation of Block Copolymer P-1 (ABA Type)

To a reactor equipped with a stirrer, a reflux condenser, a thermometer, and a nitrogen-introducing tube, 207 parts by mass of tripropylene glycol monomethyl ether, 17.6 parts by mass of benzyl methacrylate (BzMA), 29.7 parts by mass of 2-ethylhexyl methacrylate (2EHMA), 1.0 parts by mass of methacrylic acid (MAA), 2.0 parts by mass of iodide, 4.0 parts by mass of 2,2′-azobis (4-methoxy-2,4-dimethyl valeronitrile) (AMDV), and 0.08 parts by mass of diphenylmethane (DPM) were added and polymerized at 40° C. for 5 hours to obtain a polymer chain B serving as a hydrophobic block.

To the above reactant, 25.2 parts by mass of cyclohexyl methacrylate (CHMA), 10.0 parts by mass of methyl methacrylate (MMA) and 8.6 parts by mass of MAA were added and polymerized for 3 hours to form polymer chains Al serving as hydrophilic blocks, thereby obtaining AB type block copolymers composed of the polymer chains A1 and the polymer chains B.

To the above reactant, 4.3 parts by mass of BzMA and 8.6 parts by mass of MAA were added, and polymerized for 2 hours to form a polymer chain A2 serving as a hydrophilic block, thereby obtaining an ABA-type block copolymer consisting of the polymer chain A1, the polymer chain B, and the polymer chain A2.

After cooling to room temperature, a homogenized aqueous solution of 8.0 parts by mass of sodium hydroxide and 199 parts by mass of ion-exchanged water was added for neutralization. Ion-exchanged water was added to adjust the solid content, thereby obtaining an aqueous solution of an ABA-type block copolymer having a solid content of 30%. The obtained block co-polymer had a weight average molecular weight of 12000, a PDI of 1.36, and an acid number of 113 mgKOH/g.

### Preparation of Random Copolymer P-2

Into a reactor equipped with a dropping device, a thermometer, a water-cooled reflux condenser and a stirrer, 100 parts by mass of ion-exchanged water was charged, 0.4 parts by mass of ammonium persulfate as a polymerization initiator was added under stirring at 70° C. in a nitrogen gas atmosphere, and monomer solutions containing 70 parts by mass of styrene, 19 parts by mass of methyl acrylate, 31 parts by mass of MMA and 20 parts by mass of N-butyl acrylate were dropped into the reactor and reacted to polymerize, thereby producing a polymer. Thereafter, the mixture was filtered through a 0.3-μm filter, and the solid content was adjusted by adding ion-exchanged water to obtain resin particles in an emulsion state having a solid content of 30%. The weight average molecular weight of the obtained random copolymer was 8800.

### 1-2. Preparation of Pigment Dispersion

### Preparation of Pigment Dispersion A-1

To 18.0 parts by mass of REGAL330R (black pigment, manufactured by Cabot Corporation), 45.0 parts by mass of a 30% solids aqueous solution of block copolymer P-1 (pigment-dispersing agent), 20 parts by mass of propylene glycol, and 17.0 parts by mass of ion-exchanged water were added and mixed. Thereafter, the mixture was dispersed using a sand grinder filled with 50 vol % of zirconia beads having a mean particle size of 0.5 mm to prepare pigment dispersion A-1 containing 18.0% by mass of the above-described pigments.

### Preparation of Pigment Dispersion A-2

Pigment dispersion A-2 was prepared in the same manner as pigment dispersion A-1 except that as the pigment-dispersing agent, block copolymer P-1 was changed to random copolymer P-2.

### 1-3. Silicone Acrylic Resin

D-1: silicone acrylic resin (weight average molecular weight of 30000, polydimethylsiloxane (PDMS): polymethyl acrylate (PMA)=90:10 (mass ratio), nonionic, Tg 100° C.)

D-2: silicone acrylic resin (weight average molecular weight of 30000, PDMS: PMA=60:40 (mass ratio), nonionic, Tg: 120° C.)

D-3: silicone acrylic resin (weight average molecular weight of 30000, PDMS: PMA=99.5:0.5 (mass ratio), nonionic, Tg: 0° C.)

D-4: silicone acrylic resin (weight average molecular weight: 100,000, PDMS: PMA=90:10 (mass ratio), nonionic, Tg: 140° C.)

D-5: silicone acrylic resin (weight average molecular weight of 1000, PDMS: PMA=90:10 (mass ratio), nonionic, Tg: 0° C.)

The silicone acrylic resin D-3 was prepared by the following method.

### Silicone Acrylic Resin D-3

### i) Preparation of Emulsion Compositions Comprising Organopolysiloxanes

Hexamethylcyclotrisiloxane 555 g, KBM-502 (γ-methacryloxypropylmethyldimethoxysilane) 0.6 g, KBM-13 (methyltrimethoxysilane) 44 g, and sodium laurylsulfate 6 g were dissolved in ion-exchanged water 54 g to prepare Solvent 1. Further, dodecylbenzene sulfonic acid 6 g was dissolved in pure water 54 g to prepare a solvent 2. These solutions were combined and uniformly emulsified with a homomixer, and then, the mixture was diluted by gradually adding ion-exchanged water 430 g, and allowed to pass through a high-pressure homogeniser twice with pressurized 300 kgf/cm² to obtain a uniform white emulsion. The emulsion was transferred to a 2 L glass flask equipped with a stirrer, thermometer, and reflux condenser, where polymerization reaction was carried out for 24 hours at 60 to 70° C., followed by neutralization to pH6˜8 with 10% aqueous sodium bicarbonate solution 12 g to obtain a silicone emulsion composition. The nonvolatile content of the silicone emulsion composition was 44.5%.

### ii) Production of Silicone Acrylic Resin D-3 (Silicone Acrylic Graft Copolymer Resin)

While methyl methacrylate (MMA) 3 g was added dropwise to the silicone emulsion composition obtained above over 10 minutes, a peroxide and a reducing agent were added at 30° C. to perform a redox reaction, thereby performing acrylic graft copolymerization. Thus, an emulsion composition containing a silicone-acrylic graft copolymer resin was obtained. The nonvolatile content in the emulsion composition was 44.8%. The mass ratio between the content mass of the organosiloxane constitutional unit as the numerator and the content mass of the constitutional unit derived from the (meth) acrylic acid derivative as the denominator per mole of the silicone-acrylic graft copolymer resin, that is, the ratio between the organosiloxane structure and the acrylic acid structure was 99.5/0.5.

Other silicone acrylic resins D-1, D-2, D-4, and D-5 were also prepared in the same manner except that the amounts of the raw material monomers, the reaction time, and the like were changed so that the copolymerization ratio and the weight average molecular weight of the silicone acrylic resin to be obtained were as described above.

### 1-4. Anionic Water-Dispersible Resin

E-1: urethane resin (SUPERFLEX 300 manufactured by Dai-ichi Kogyo Seiyaku Co., Ltd., Tg: −42° C.

E-2: acrylic resin (Mowinyl 6751D manufactured by The Nippon Synthetic Chemical Industry Co., Ltd., Tg: −32° C.

The Tg is a value measured by differential scanning calorimetry in accordance with JIS K 7121 under the measurement conditions of a heating rate 10° C./min.

### 1-5. Crosslinking Agent

FIXER N (blocked isocyanate-based crosslinking agent) manufactured by Matsui Shikiso Chemical Industry

Co., Ltd

### 1-6. Preparation of Ink

### Preparation of Ink 1-1

The following components were mixed so that the total amount became 100 parts by mass to prepare a water-based ink 1-1.
Pigment dispersion A-1:10.0 parts by mass
Silicone acrylic resin D-1:0.5 parts by mass
Urethane resin E-1 (anionic water-dispersible resin): 10.0 parts by mass
Glycerin (solvent): 10 parts by mass
Ethylene glycol (EG) (solvent): 20 parts by mass
Proxel GXL(S) (preservative): 0.1 part by mass
Olfine E1010 (manufactured by Nissin Chemical Industry Co., Ltd., surfactant): 0.1 part by mass
Ion-exchanged water: remaining amount

### Preparation of Inks 1-2 to 1-13

Inks 1-2 to 1-13 were obtained in the same manner as in the case of the ink 1-1 except that the types and the contents of the pigment-dispersing agent, the silicone acrylic resin, and the binder resin were changed as illustrated in Table 1, and the amount of the ion-exchanged water was adjusted such that the total amount became 100 parts by mass.

### Preparation of Ink 1-14

Ink 1-14 was obtained in the same manner as Ink 1-1 except that 0.5 parts by mass of the silicone acrylic resin was changed to 0.5 parts by mass of a silicone-based surfactant (manufactured by Evonik, TEGOWET250, Inc), and the amount of ion-exchanged water was adjusted such that the total amount became 100 parts by mass.

The compositions of the main components of the obtained ink 1-1 to 1-14 are listed in Table 1.

TABLE 1

| | | Pigment- | | Silicone acrylic | | | | Crosslinking | | |
|---|---|---|---|---|---|---|---|---|---|---|
| | | dispersing agent | | resin | | Binder resin | | agent | Solvent | |
| | Pigment | | Content | | Content | | Content | Content | Glycerin | EG |
| Ink | dispersion | | [% by | | [% by | | [% by | [% by | [% by | [% by |
| No. | No. | Type | mass] | Type | mass] | Type | mass] | mass] | mass] | mass] |
| 1-1 | A-1 | P-1 | 0.8 | D-1 | 0.5 | E-1 | 10 | — | 10 | 30 |
| 1-2 | | | | | | E-2 | | — | 10 | 30 |
| 1-3 | | | | D-2 | | E-1 | | — | 10 | 30 |
| 1-4 | | | | D-3 | | E-1 | | — | 10 | 30 |
| 1-5 | | | | D-4 | | E-1 | | — | 10 | 30 |
| 1-6 | | | | D-5 | | E-1 | | — | 10 | 30 |
| 1-7 | | | 0.8 | D-1 | 1 | E-1 | 5 | — | 10 | 30 |
| 1-8 | | | 0.8 | D-1 | 5 | E-1 | 10 | — | 10 | 30 |
| 1-9 | A-2 | P-2 | 0.8 | D-1 | 0.5 | E-1 | 10 | — | 10 | 30 |
| 1-10 | A-1 | P-1 | 0.8 | — | | E-1 | 10 | — | 10 | 30 |
| 1-11 | A-1 | P-1 | 0.8 | D-1 | 0.5 | — | | — | 10 | 30 |
| 1-12 | A-1 | P-1 | 0.8 | D-1 | 0.5 | E-1 | 10 | 1 | 10 | 30 |

| | | | | | | | | | |
|---|---|---|---|---|---|---|---|---|---|
| 1-13 | A-2 | P-2 | 0.8 | — | E-1 | 10 | — | 10 | 30 |
| 1-14 | A-1 | P-1 | 0.8 | Silicone-based | E-1 | 10 | — | 10 | 30 |
| | | | | surfactant | | | | | |

### 2. Preparation of Treatment Liquid

### 2-1. First Treatment Liquid

Preparation of first treatment liquid 2-1

The following components were mixed so that the total amount was adjusted to 100 parts by mass, thereby preparing a first treatment liquid 2-1.
UNISENCE-KHE 100 L (aggregating agent) (manufactured by Senka Co., Ltd., cationic resin, cation value 4.4 mmol/g): 3.0 parts by mass
Glycerin (solvent): 10.0 parts by mass
Ethylene glycol (solvent): 30.0 parts by mass
Proxel GXL(S) (preservative): 0.1 part by mass
Olfine E1010 (manufactured by Nissin Chemical Industry Co., Ltd., surfactant): 0.1 part by mass
Ion-exchanged water: remaining amount
   Preparation of first treatment liquid 2-2

A first treatment liquid 2-2 was obtained in the same manner as in the case of the first treatment liquid 2-1 except that the aggregating agent was changed to MPT-60 (manufactured by Mitsubishi Pencil Corporation, cationic resin, cation value 5.5 mmol/g) having a cation value higher than that of the aggregating agent used in the first treatment liquid 2-1.)

Note that the cation value of the cationic resin was a value measured by the following colloid titration method.
(1) An aqueous dispersion of a resin is prepared.
(2) Toluidine blue is added as an indicator.
(3) PVSK (Potassium polyvinyl sulfate) solution is used as the titrant. The end point is reached when the discoloration of the dispersion liquid changes from blue to red.
(4) The cation value is calculated from the resin amount (solid content) in the aqueous dispersion and the titration amount of the PVSK solution.

### 2-2. Second Treatment Liquid

### Preparation of Second Treatment Liquid 3-1

The following components were mixed so that the total amount was 100 parts by mass, thereby preparing a second treatment liquid 3-1.
Urethane resin E-1 (anionic water-dispersible resin): 10.0 parts by mass
Glycerin (solvent): 10.0 parts by mass
Ethylene glycol (solvent): 30.0 parts by mass
Proxel GXL(S) (preservative): 0.1 part by mass
Olfine E1010 (manufactured by Nissin Chemical Industry Co., Ltd., surfactant): 0.1 part by mass
Ion-exchanged water: remaining amount

### 4. Image Formation and Evaluation

### Test 1

### Step of Preparing Treated Fabric

As a fabric, Cotton Broad 40 (100% cotton) was prepared.

After this fabric was immersed in a bath filled with the first treatment liquid 2-1, the excess first treatment liquid was squeezed out with a mangle roll, and the first treatment liquid was applied so that the application amount of the first treatment liquid was adjusted to 30 g/m².

Next, the fabric to which the first treatment liquid had been applied was dried at 130° C. for 10 minutes to obtain a treated fabric. The remaining amount of the aqueous solvent on the treated fabric was about 5.0% by mass of the applied aqueous solvent (the amount of the aqueous solvent on the treated fabric was 3.0 g/m²).

### Step of Applying Ink

The ink 1-1 and the second treatment liquid 3-1 were set in a simple printing tester equipped with a KM1024i head as an inkjet head.

Next, using a simple printing tester, the prepared ink was applied to the surface of the above-described pretreated fabric so as to achieve an application amount of 20 g/m².

Next, the second treatment liquid 3-1 was applied at an application amount of 15 g/m².

The step of applying the ink and the second treatment liquid was repeated so that the applied ink and the second treatment liquid overlapped each other, and the ink and the second treatment liquid were each applied eight times to form an image.

Note that all of these applications were performed using an inkjet method and a multi-pass method with main scanning 540 dpi×and sub-scanning 720 dpi. Herein, “dpi” stands for the number of ink droplets (dots) per 2.54 cm. The ejection frequency was set to 22. 4kHz. The image to be formed was an image including a fine line grid, gradation, and a solid portion (200 mm ×200 mm as a whole).

### Drying and Fixing Step

Thereafter, the fabric on which the image was formed was dried at 130° C. for 10 minutes by a belt conveying type dryer. Thus, an image-formed product was obtained.

### Tests 2 to 17

Image formation was performed in the same manner as in Test 1 except that at least one of the type of ink and the type of second treatment liquid was changed as shown in Table 2.

### 5 Evaluation

The following evaluations are performed on the obtained image-formed product.

### (1) Ejection Stability

Under conditions of 25° C. and 50% RH, the prepared ink was ejected by a line system with a fixed KM1024iMHE manufactured by Konica Minolta, Inc. under ejection conditions corresponding to a droplet ejection amount of 13 pL. After it was confirmed that the filled ink was discharged from all the nozzles at the start of discharge, the ink was continuously discharged for 60 minutes. Then, after the completion of the continuous ejection for 60 minutes, the number of nozzles that were able to eject to the end (the number of ejection nozzles after the completion of the continuous ejection for 60 minutes) was counted.

Then, the ejection stability was evaluated based on the following evaluation criterion.
o: the number of ejection nozzles after the completion of the continuous ejection for 60 minutes is 60
Δ: the number of ejection nozzles after the completion of the continuous ejection for 60 minutes is between 55 or more and 60 or less
^{x}: the number of ejection nozzles after the completion of the continuous ejection for 60 minutes is less than 55
Δ or more was defined as an allowable range.

### (2) Friction Fastness

A white cotton rubbing cloth was rubbed back and forth 100 times under the load of a 200 g on the 100 mm×100 mm area in the formed image to provide friction. As the white cotton cloth for rubbing, a white cotton cloth wetted with water to be in a wet state of about 100% was used. After the rubbing, the color transfer to the white cotton cloth for friction was observed, and the wet friction fastness was evaluated according to the following standard.
⊚: almost no color transfer
o: slight color transfer but level is satisfactory
Δ: color transfer but within an allowable range
^{x}: color transfer and exceeding an allowable range
Δ or more was defined as an allowable range.

### (3) Density Unevenness and Color Unevenness

The solid quality of the entire solid image formed was visually observed and evaluated according to the following standard.
o: satisfactory image in which wettability of ink is excellent, which is a uniform image without density unevenness, and in which no omission of ink is observed
Δ: practically acceptable image in which wettability of ink is satisfactory, there are places with different shading, but no ink omission is observed
^{x}: image in which the wettability of the ink is slightly insufficient, there is a portion where the ink has fallen off, and a slight white spot has occurred
^{xx}: image in which wettability of ink is insufficient, there is a place where ink is dropped off, and a white spot conspicuously occurs
Δ or more was defined as an allowable range.

### (4) Texture

The texture of the obtained image-formed product and the material was sensuously evaluated by touching with fingers. The evaluation was performed based on the following standard.
o: the original softness of the material is maintained, almost the same as before the image formation.
Δ: although slightly harder than before the image formation, the texture of the material is not impaired and is at a level causing no practical problem
ₓ: hardened as compared with before the image formation, texture of the material is impaired, at a level causing a practical problem
Δ or more was defined as an allowable range.

The evaluation results of Tests 1 to 17 are shown in Table 2.

TABLE 2

| | Ink | | | | | | | | | | | | | |
|---|---|---|---|---|---|---|---|---|---|---|---|---|---|---|
| | | | | | | | Cross- | | | | | | | |
| | | | Silicone acrylic | | | | linking | | | | | | | |
| | | Pigment | resin | | Binder resin | | agent | First | Second | Evaluation | | | | |
| | | disper- | | Content | | Content | Content | treatment | treatment | | Density/ | | | |
| Test | | sion | | [% by | | [% by | [% by | liquid | liquid | Ejection | color | Friction | | |
| No. | No. | No. | Type | mass] | Type | mass] | mass] | No. | No. | stability | unevenness | fastness | Texture | Remarks |
| 1 | 1-1 | A-1 | D-1 | 0.5 | E-1 | 10 | — | 2-1 | 3-1 | ◯ | ◯ | ◯ | ◯ | Ex. |
| 2 | 1-1 | | D-1 | | E-1 | | — | | — | ◯ | Δ | Δ | ◯ | Ex. |
| 3 | 1-2 | | D-1 | | E-2 | | — | | 3-1 | ◯ | ◯ | ◯ | ◯ | Ex. |
| 4 | 1-3 | | D-2 | | E-1 | | — | | 3-1 | ◯ | ◯ | Δ | ◯ | Ex. |
| 5 | 1-4 | | D-3 | | E-1 | | — | | 3-1 | ◯ | ◯ | ◯ | ◯ | Ex. |
| 6 | 1-5 | | D-4 | | E-1 | | — | | 3-1 | Δ | ◯ | ⊚ | Δ | Ex. |
| 7 | 1-6 | | D-5 | | E-1 | | — | | 3-1 | ◯ | Δ | Δ | ◯ | Ex. |
| 8 | 1-7 | A-1 | D-1 | 1 | E-1 | 5 | — | | 3-1 | ◯ | ◯ | Δ | Δ | Ex. |
| 9 | 1-8 | A-1 | D-1 | 5 | E-1 | 10 | — | | 3-1 | ◯ | ◯ | ◯ | Δ | Ex. |
| 10 | 1-9 | A-2 | D-1 | 0.5 | E-1 | 10 | — | | 3-1 | Δ | Δ | X | Δ | Comp. Ex. |
| 11 | 1-10 | A-1 | — | | E-1 | 10 | — | | 3-1 | ◯ | X | Δ | ◯ | Comp. Ex. |
| 12 | 1-1 | A-1 | D-1 | 0.5 | E-1 | 10 | — | 2-2 | 3-1 | ◯ | ◯ | ◯ | ◯ | Example |
| 13 | 1-11 | A-1 | D-1 | 0.5 | — | | — | 2-1 | 3-1 | ◯ | Δ | Δ | ◯ | Example |
| 14 | 1-12 | A-1 | D-1 | 0.5 | E-1 | 10 | 1 | 2-1 | 3-1 | ◯ | ◯ | ⊚ | Δ | Example |

| | | | | | | | | | | | | | |
|---|---|---|---|---|---|---|---|---|---|---|---|---|---|
| 15 | 1-13 | A-2 | — | E-1 | 10 | — | 2-1 | 3-1 | Δ | Δ | X | ◯ | Comp. Ex. |
| 16 | 1-14 | A-1 | Silicone-based | E-1 | 10 | — | 2-1 | 3-1 | Δ | ◯ | X | ◯ | Comp. Ex. |
| | | | surfactant | | | | | | | | | | |
| 17 | 1-10 | A-1 | — | E-1 | 10 | — | 2-2 | 3-1 | ◯ | XX | Δ | ◯ | Comp. Ex. |

As illustrated in Table 2, it is found that when the ink containing the random copolymer is applied to the pretreated fabric in a dry state, the friction fastness is low (Test 10). On the other hand, when an ink containing a block copolymer and not containing a silicone acrylic resin is applied to a pretreated fabric in a dry state, the friction fastness can be improved to some extent, but density unevenness and color unevenness occur (Test 11).

In contrast, it is found that when the ink containing the block copolymer and the silicone acrylic resin is applied to the pretreated fabric in a dry state, the density unevenness and the color unevenness can be suppressed while the friction fastness is improved (Tests 1 to 9 and 12 to 14).

In particular, it can be seen that the higher the content ratio of the constituent unit derived from PDMS in the silicone acrylic resin is, such as 80% by mass or more, the more the friction fastness improves (comparison between Tests 1, 4 and 5).

In addition, it is found that as the weight average molecular weight of the silicone acrylic resin is as high as 30000 or more, the density and color unevenness can be further suppressed, and the friction fastness is further improved (comparison of Tests 1, 6, and 7).

In addition, it is found that when E-1 containing an acrylic resin is used as the second treatment liquid, the density and color unevenness can be further suppressed, and the friction fastness is further improved (comparison between Tests 2 and 3).

In addition, when the treatment liquid 2-2 containing an aggregating agent having a high cation value is used, the unevenness in density and color unevenness is more remarkably generated (Test 17), but it is found that the unevenness in density and color unevenness can be favorably suppressed by using the ink 1-1 (Test 11).

In addition, it is found that even when a silicone-based surfactant is used instead of the silicone acrylic resin, the ejection stability is lowered and the friction fastness is also lowered (comparison between Tests 1 and 16).

### Industrial Applicability

According to the present invention, it is possible to provide an image forming method capable of forming an image having high friction fastness on a fabric while suppressing density unevenness and color unevenness even on a fabric treated off-line.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming method, comprising:
preparing a fabric to which a cationic aggregating agent is attached, the fabric being in a dry state;
applying an ink including a pigment, an anionic block copolymer, a silicone acrylic resin, and an aqueous solvent onto the fabric by an inkjet method, wherein
the anionic block copolymer contains a hydrophilic block A and a hydrophobic block B.

2. The image forming method according to claim 1, wherein
the preparing the fabric includes
applying a treatment liquid including the cationic aggregating agent and an aqueous solvent to the fabric, and
drying the fabric to which the treatment liquid has been applied.

3. The image forming method according to claim 2, wherein
in the drying,
the drying is performed until a remaining amount of the aqueous solvent in the fabric becomes 20% by mass or less with respect to a total amount of the aqueous solvent applied to the fabric.

4. The image forming method according to claim 1, wherein
the anionic block copolymer contains two hydrophilic blocks A disposed at both ends of a molecule of the anionic block copolymer and the hydrophobic block B disposed between the two hydrophilic blocks A, each of the two hydrophilic blocks A being one of a plurality of the hydrophilic blocks A.

5. The image forming method according to claim 1, wherein:
the silicone acrylic resin includes a constituent unit X derived from a polyorganosiloxane having a radically polymerizable group, and a constituent unit Y derived from a (meth) acrylic acid ester; and
a content of the constituent unit X is 80% by mass or more and 99% by mass or less with respect to a sum of an amount of the constituent unit X and an amount of the constituent unit Y.

6. The image forming method according to claim 1, wherein
the silicone acrylic resin has a weight average molecular weight of 1,000 or more and 500,000 or less.

7. The image forming method according to claim 1, wherein
a content of the silicone acrylic resin in the ink is 0.2% by mass or more and 10% by mass or less with respect to the ink.

8. The image forming method according to claim 1, wherein
the ink further includes an anionic water-dispersible resin different from the anionic block copolymer.

9. The image forming method according to claim 1, further comprising:
applying a second treatment liquid including a water-dispersible resin and an aqueous solvent onto the fabric to which the ink has been applied.

10. The image forming method according to claim 8, wherein
the anionic water-dispersible resin includes a (meth) acrylic resin or a urethane resin.

11. The image forming method according to claim 9, wherein
at least one of the ink and the second treatment liquid further includes a crosslinking agent.

12. The image forming method according to claim 1, wherein
the aggregating agent contains a polyvalent metal salt or a compound having a cationic group.

13. The image forming method according to claim 12, wherein
the compound having the cationic group includes a cationic resin.
